(19) United States
(12) Patent Application Publication
(10) Pub. No.: US 2015/0002456 A1
(43) Pub. Date: Jan. 1, 2015

(54) TOUCH-SENSING LIQUID CRYSTAL DISPLAY

(71) Applicant: HannStar Display Corporation, New Taipei City (TW)

(72) Inventors: Chia-Hua YU, New Taipei City (TW); Sung-Chun LIN, Tainan City (TW); Chung-Lin CHANG, Kaohsiung City (TW); Chien-Ting CHAN, Tainan City (TW); Hsuan-Chen LIU, Kaohsiung City (TW)

(73) Assignee: HannStar Display Corporation, New Taipei City (TW)

(21) Appl. No.: 14/279,339

(22) Filed: May 16, 2014

(30) Foreign Application Priority Data
Jun. 27, 2013 (CN) 201310260985.7

(51) Int. Cl. G09G 3/34; G09G 3/36; G06F 3/044

(52) U.S. Cl. CPC G09G 3/3406; G06F 3/044; G09G 3/3648
USPC 345/174; 345/102

(57) ABSTRACT

A touch-sensing liquid crystal display is provided and includes a display panel and a backlight module. The display panel includes a transistor substrate, a liquid crystal layer and a common electrode. The liquid crystal layer is disposed on the transistor substrate. The common electrode is disposed on the liquid crystal layer. The transistor substrate includes data lines, scan lines, pixel units and a shield layer. The data lines are used to receive first signals. The scan lines are used to receive second signals. The pixel units include pixel electrodes and transistor switches, in which the transistor switches are electrically connected to the data lines, the scan lines and the pixel electrodes. The shield layer is disposed between the pixel electrodes and the transistor switches. The backlight module is disposed on the display panel, in which the liquid crystal layer is sandwiched between the shield layer and the backlight module.

### RELATED APPLICATIONS

This application claims priority to Chinese Application Serial Number 201310260985.7, filed Jun. 27, 2013, which is herein incorporated by reference.

### BACKGROUND

1. Field of Invention

The present disclosure relates to a touch-sensing liquid crystal display. More particularly, the present disclosure relates to a liquid crystal panel without assembling an additional touch-sensing array.

2. Description of Related Art

In recent years, light and thin flat displays have become extensively used displays in various types of electronic products. For achieving use convenience, a brief appearance and multiple functions, input devices, such as conventional keyboards or mice, are replaced by touch-sensing panels as the input devices for many information products.

With a rapid technical development of flat displays and touch-sensing input devices, in order to have a larger visible frame and provide a more convenient operating mode under a limited volume, in some electronic products, the touch-sensing panels are combined with display panels to form touch display panels. Because having both a display function of the display panels and input operation convenience through the touch panels, the touch display panels have gradually become important equipment of the electronic products, such as a handheld PC, a personal digital assistance (FDA) or a smart phone, etc.

The operating principle of the touch-sensing panel is that, when a conductive object (such as a finger) contacts a touch-sensing array of the touch-sensing panel, an electrical property (such as resistance or capacitance) of the touch-sensing array is changed and induces a bias change of the touch-sensing array. The change of the electrical property will be transformed to a control signal transmitted to an external control circuit, and processed and calculated by a processor to obtain a result. Then, a display signal is outputted to the display panel by the external control circuit, and an image is displayed before a user's eyes by the display panel.

However, it needs the additional touching-sensing array for the touch-sensing panel to perform a sensing operation, so as to raise cost of the displays. Therefore, a touch-sensing display without assembling the touch-sensing array is needed.

### SUMMARY

An aspect of the present disclosure is to provide a touch-sensing liquid crystal display, in which scan lines and data lines of the display itself are used as a touch-sensing array, such that an additional touch-sensing array is not required to be assembled.

According to an embodiment of the present disclosure, the touch-sensing liquid crystal display includes a display panel and a backlight module. The display panel includes a transistor substrate, a liquid crystal layer and a common electrode. The liquid crystal layer is disposed on the transistor. The common electrode is disposed on the liquid crystal layer, in which a common voltage is applied to the common electrode. The transistor substrate includes data lines, scan lines, pixel units and a shield layer. The data lines are used to receive first signals including image data signals or touch-sensing detecting signals. The scan lines are used to receive second signals including switch signals or touch-sensing scan signals. The pixel units include pixel electrodes and transistor switches, in which the transistor switches are connected electrically to the data lines, the scan lines and the pixel electrodes, in which the first signals are applied to the pixel electrodes according to the second signals. The shield layer is disposed between the pixel electrodes and the transistor switches, in which a reference voltage is applied to the shield layer. The backlight module is disposed on the display panel, in which the liquid crystal layer is sandwiched between the shield layer and the backlight module.

It can be known from the above description that, in the touch-sensing liquid crystal display of an embodiment of the present disclosure prevents from a noise of the liquid crystal layer coupled to the scan lines and the data lines of the transistor substrate, such that the scan lines and the data lines of the transistor substrate may be used as the touch-sensing array and an additional touch-sensing array is not required to be assembled.

### BRIEF DESCRIPTION OF THE DRAWINGS

These and other features, aspects, advantages and embodiments of the present disclosure will become better understood with regard to the following accompanying drawings where:

FIG. 1 is a schematic cross-sectional structural diagram showing a touch-sensing liquid crystal display in accordance with an embodiment of the present disclosure;

FIG. 2 is a schematic flow chart showing a method for fabricating a transistor substrate in accordance with an embodiment of the present disclosure;

FIG. 3a to FIG. 3i are schematic cross-sectional structural views of the display in accordance with each step corresponding to the method; and

FIG. 4 is a schematic cross-sectional structural top view of a shield layer in accordance with an embodiment of the present disclosure.

### DETAILED DESCRIPTION

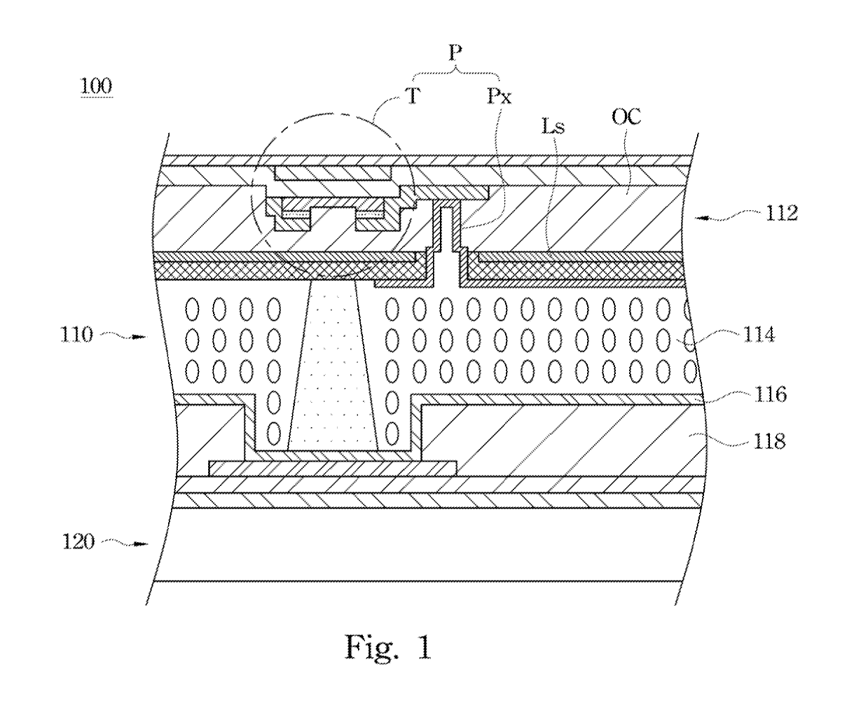

Referring to FIG. 1, FIG. 1 is a schematic cross-sectional structural diagram showing a touch-sensing liquid crystal display 100 in accordance with an embodiment of the present disclosure. A touch-sensing liquid crystal display 100 includes a display 110, a transistor substrate 112, a liquid crystal layer 114 and a common electrode 116, in which the liquid crystal layer 114 is disposed on the transistor substrate 112, and the common electrode 116 is disposed on the liquid crystal layer 114, in which a common voltage is applied to the common electrode 116. In the embodiment of the present disclosure, the touch-sensing liquid crystal display 100 may further include a color filter 118, but the embodiment of the present disclosure is not limited thereto. In other embodiments of the present disclosure, the touch-sensing liquid crystal display may not include a color filter 118.

The transistor substrate 112 includes scan lines and data lines (not shown), pixel units P and a shield layer Ls. Each of the pixel units P includes a transistor switch T and a pixel electrode Px. The transistor switch T is electrically connected to the corresponding data lines and the corresponding scan lines of the pixel unit, in which the first signals received by the data lines are applied to the pixel electrode Px according to second signals received by the scan lines. Therefore, each pixel unit P may display a corresponding pixel color. In some embodiments, the first signals include image data signals or touch-sensing detecting signals, and the second signals include switch signals or touch-sensing scan signals.

In the present embodiment, a shield layer Ls is between the liquid crystal layer 114 and the transistor switch T. The shield layer Ls is used to block capacitor interference in the liquid crystal layer 114 for improving a touch-sensing efficacy. A fixed reference voltage is applied to the shield layer Ls. In the present embodiment, the reference voltage has the same value as the common voltage, but embodiments of the present disclosure are not limited thereto. In other embodiments of the present disclosure, the reference voltage may have a different value from the common voltage.

In addition, the touch-sensing liquid crystal display 100 of the embodiment may have an isolating layer OC. The isolating layer OC is disposed between the transistor switch T and the shield layer Ls to provide a further blocking effect for blocking the capacitor interference in the liquid crystal layer 114. In the present embodiment, the isolating layer OC is formed from a material such as a Si-containing material or an organic material. The isolating layer OC has a transmittance between about 60% and about 99%, and the isolating layer OC has a thickness between about 0.2 μm and about 3 μm, but embodiments of the present disclosure are not limited thereto. In other embodiments of the present disclosure, the isolating layer OC has a transmittance between about 10% and about 60%, and the isolating layer OC has a thickness between about 1 μpm and about 5 μm.

The touch-sensing liquid crystal display 100 of the present embodiment uses the data lines and the scan lines of the transistor substrate 112 as a touch-sensing array. The data lines and the scan lines are arranged orthogonally, so as to be operated as the touch-sensing array. When the display panel 110 and the backlight module 120 are assembled together, the transistor substrate 112 of the display panel 110 faces outwards i.e., the liquid crystal layer 114 is sandwiched between the shield layer Ls of the transistor substrate 112 and the backlight module 120. Therefore, the touch-sensing liquid crystal display 100 of the present embodiment may use the data lines and the scan lines of the transistor substrate 112 to detect an action made by a user. For example, when the user touches an area on the transistor substrate 112, the capacitance at the area is changed. A sensor may determine the capacitance and a position touched by the user based on an intersection of the data lines and the scan lines in the area accordingly. Then, a signal is transmitted to a processor of the touch-sensing liquid crystal display 100, thereby enabling the touch-sensing liquid crystal display 100 to perform a corresponding operation.

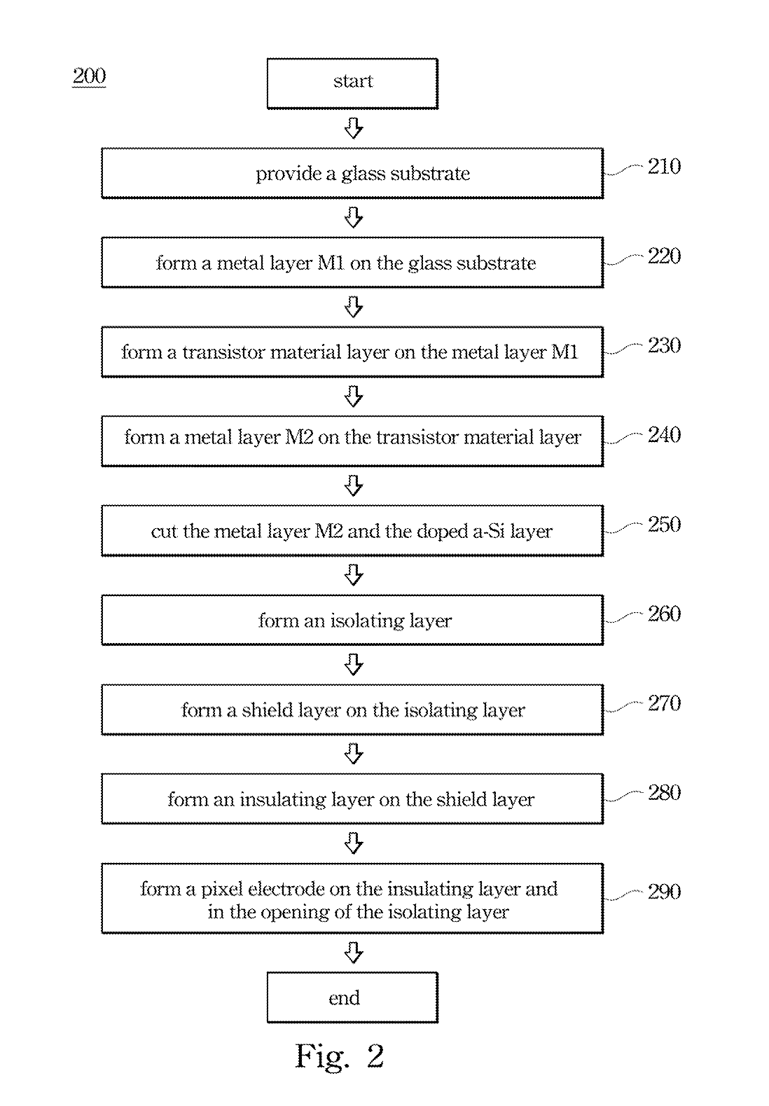

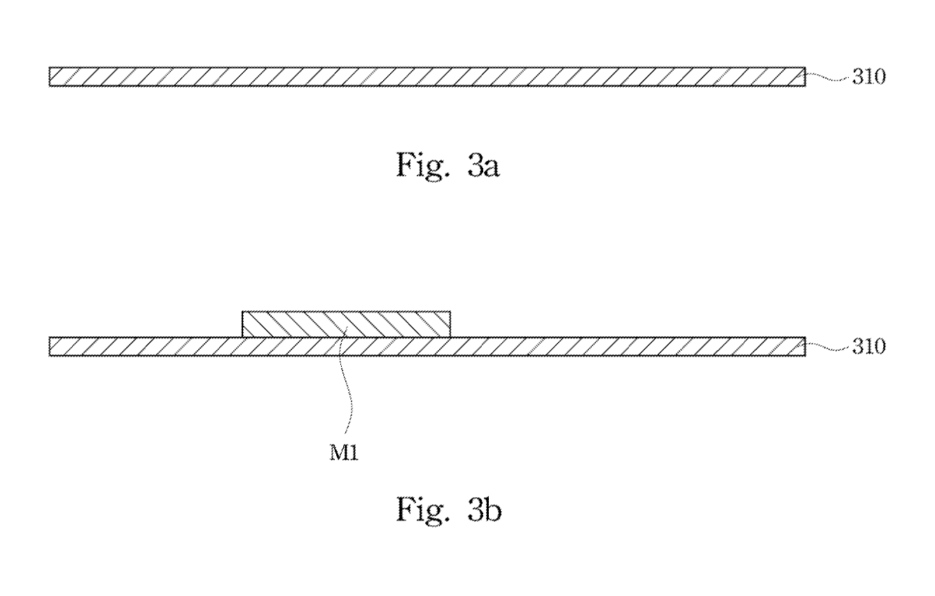

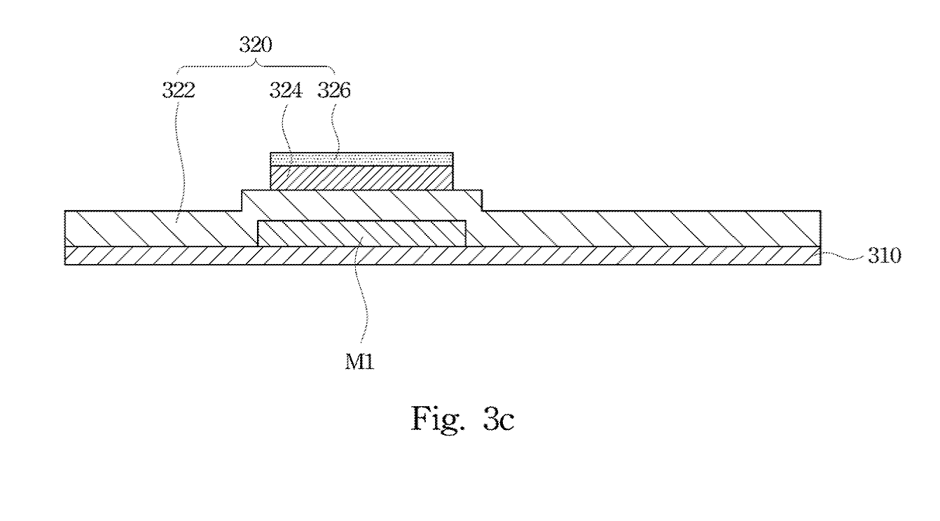

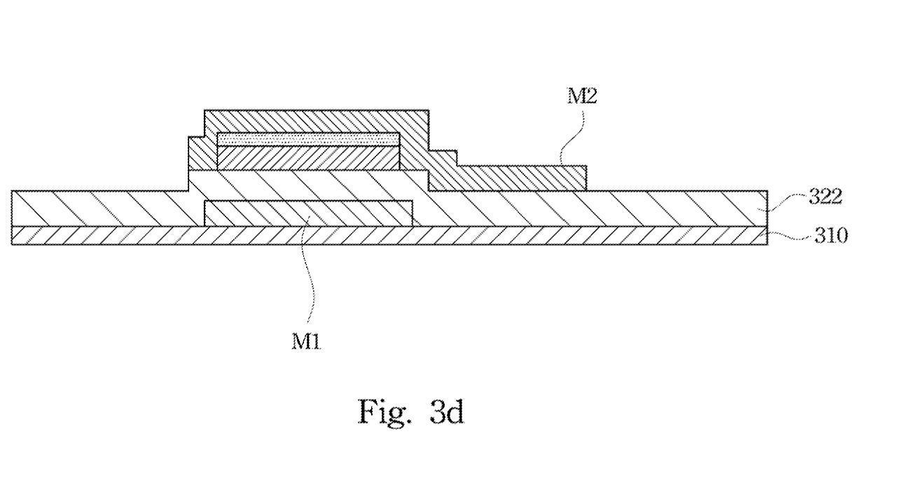

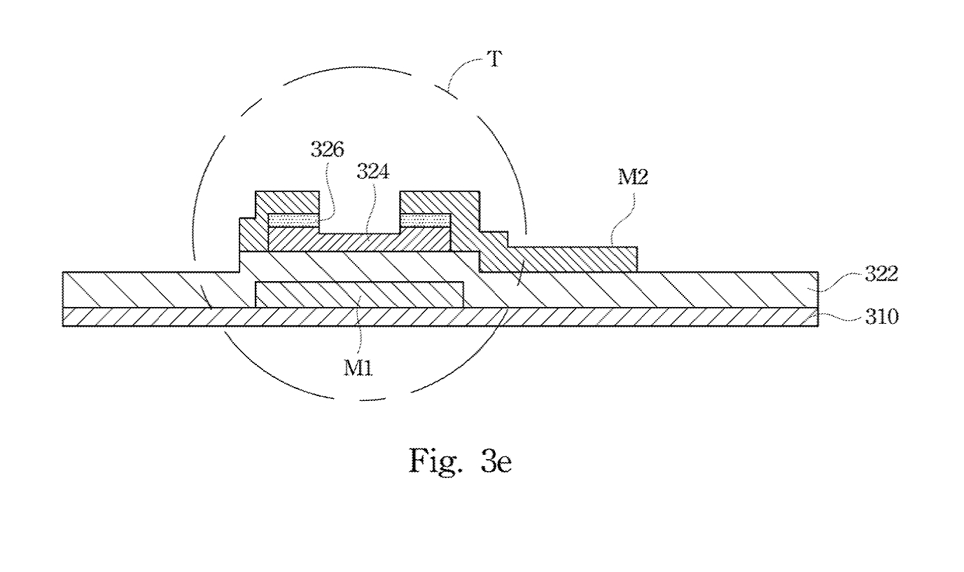

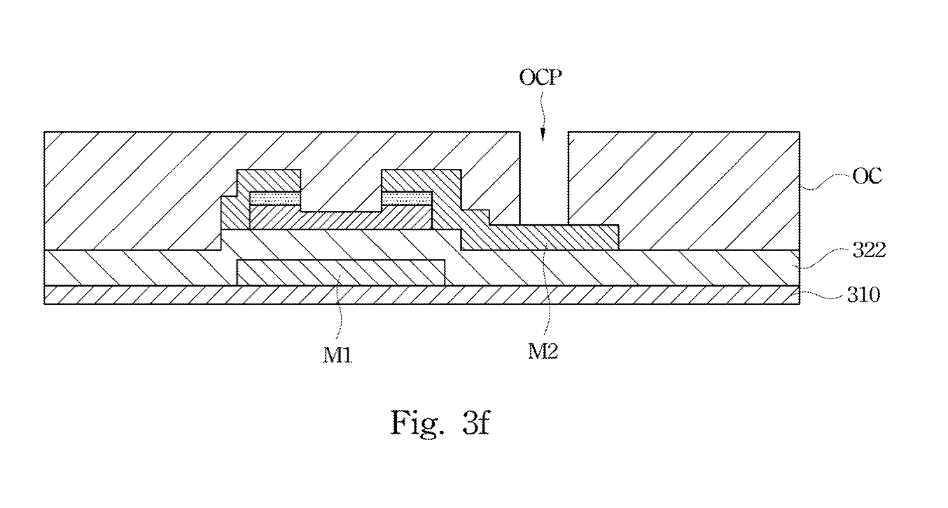

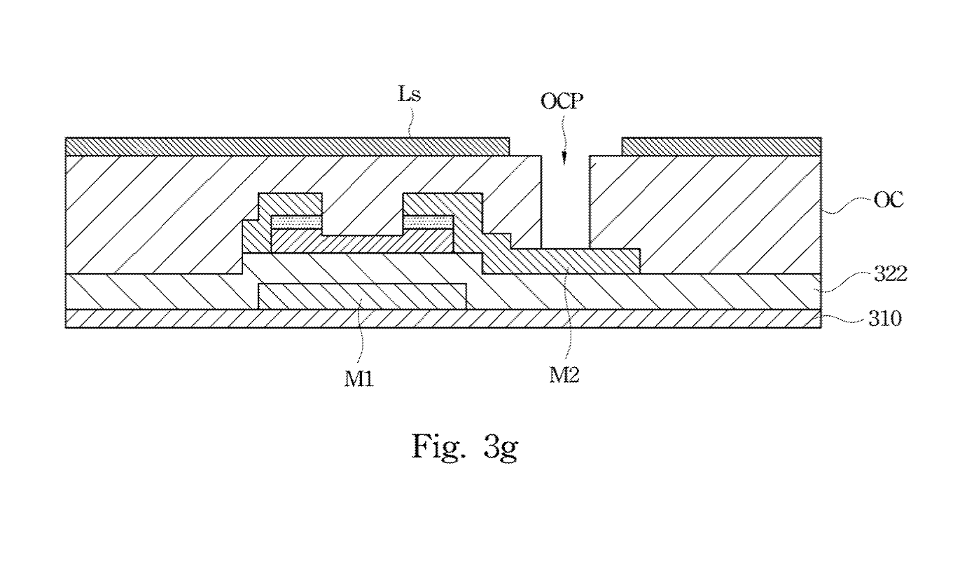

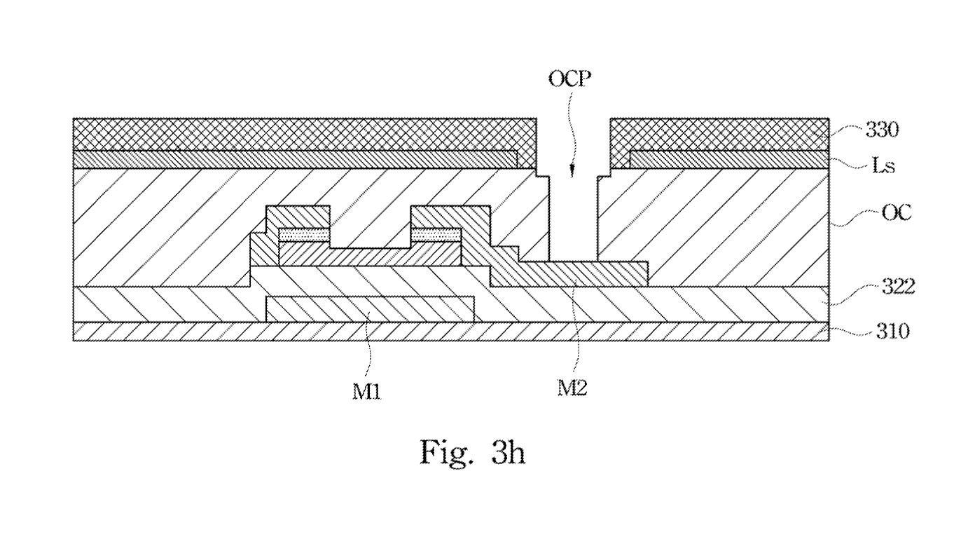

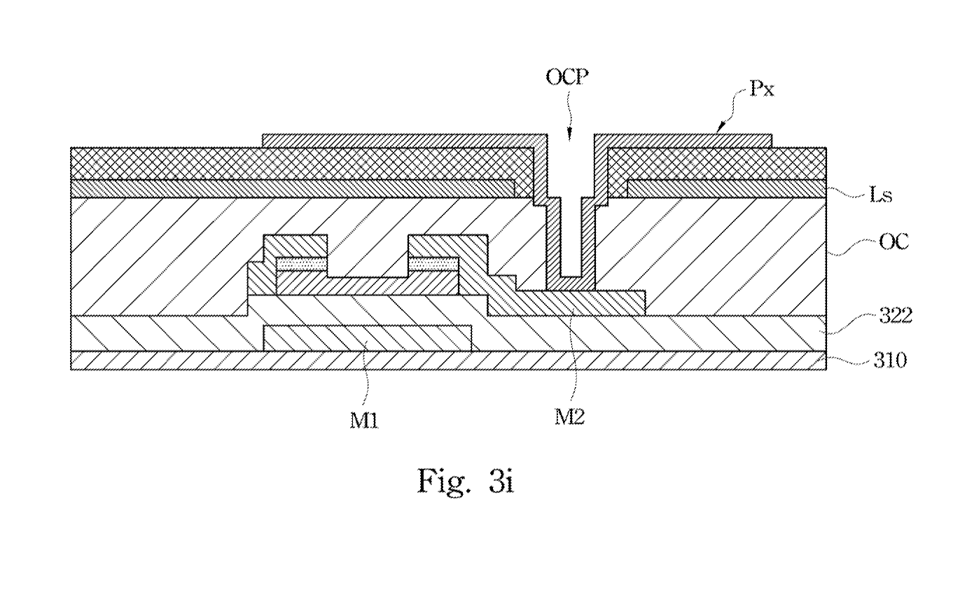

Referring to FIG. 2 together with FIG. 3a to FIG. 3i, FIG. 2 is a schematic flow chart showing a method 200 for fabricating a transistor substrate 112 in accordance with an embodiment of the present disclosure. FIG. 3a to FIG. 3h are schematic cross-sectional structural views of the display in accordance with each step corresponding to the method 220. In the method 200, at first, step 210 is performed to provide a glass substrate 310, as shown in FIG. 3a. Then, step 220 is performed to form a metal layer M1 on the glass substrate 310, as shown in FIG. 3b. In the present embodiment, the metal layer M1 is used as scan lines or connecting lines for connecting pixel units to the scan lines.

After step 220, step 230 is performed to provide a transistor material layer 320 as shown in FIG. 3c. The transistor material layer 320 is formed on the metal layer M1 and has a three-layers structure. In the present embodiment, the transistor material layer 320 includes an insulating layer 322, an amorphous silicon (a-Si) layer 324 and an n+ doped a-Si layer 326, but embodiments of the present disclosure are not limited thereto. In other embodiments of the present disclosure, a polysilicon material may be used to replace an a-Si material in the transistor material layer 320.

After step 230, step 240 is performed to form a metal layer M2 on the transistor material layer 320 as shown in FIG. 3d. In the present embodiment, the metal layer M2 is used as data lines or connecting lines for connecting pixel units to the data lines.

After step 240, step 250 is performed to cut the metal layer M2 and the n+ doped a-Si layer 326 for forming a transistor switch T, as shown in FIG. 3e. The cut-out n+ doped a-Si layers 326 are used to form a source/drain of the transistor switch T.

After step 250a step 260 is performed to form an isolating layer OC, as shown in FIG. 3f. The isolating layer has an opening OCP for exposing the metal layer M2 below the isolating layer OC. As described above, the isolating layer OC may block capacitor interference in a liquid crystal layer. The material and thickness of the isolating layer OC has been described above, and thus are not repeated herein.

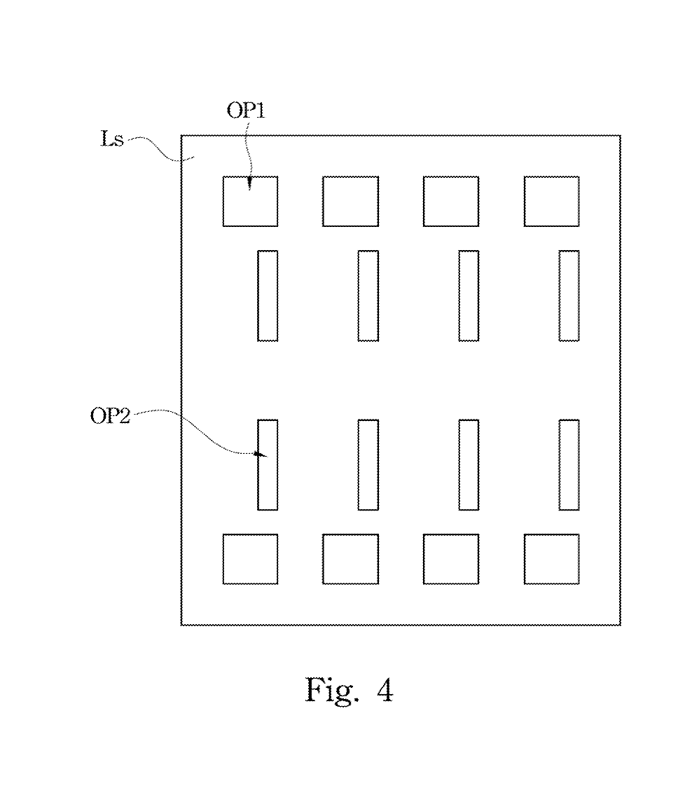

After step 260, step 270 is performed to form a shield layer Ls on the isolating layer OC, as shown in FIG. 3g. As described above, the isolating layer OC is used to block the capacitor interference in the liquid crystal layer. Therefore, the shield layer Ls of the present embodiment is disposed correspondingly according to a position of the scan lines and the data lines. Referring to FIG. 4, FIG. 4 is a schematic cross-sectional structural top view of a shield layer in accordance with an embodiment of the present disclosure. The shield layer Ls is a one-piece structure for blocking the capacitor interference in the liquid crystal layer. The shield layer Ls has openings OP1 and OP2, in which the opening OP1 is disposed corresponding to the opening OCP and the opening OP2 is used to adjust a storage capacitor (Cst) of a pixel. It is worthy to be noted that a pattern structure of the shield layer Ls is not limited to the present embodiment. In other embodiments of the present disclosure, the pattern structure of the shield layer Ls may be varied according to differences of user's requirements, thereby adjusting the corresponding storage capacitor (Cst) of the pixel.

Referring back to FIG. 2, after step 270, step 280 is performed to form an insulating layer 330 on the shield layer Ls for electrically isolating the shield layer Ls, as shown in FIG. 3h.

After step 280, step 290 is performed to form a pixel electrode, as shown in FIG. 3i. In the present embodiment, the pixel electrode is formed on the insulating layer 330 and in the opening OCP of the isolating layer OC for electrically connecting the metal layer M2 to the pixel electrode. When the transistor switch T is on, a data signal of the pixel is transmitted to the pixel electrode Px through the metal layer M2 so as to apply the data signal to the pixel electrode Px.

It can be known from the above description that, the touch-sensing liquid crystal display 100 of the present embodiment uses the shield layer Ls to prevent from a noise of the liquid crystal layer from coupling to the scan lines and the data lines of the transistor substrate, such that the touch-sensing liquid crystal display 100 may be used as the touch-sensing array without needing to assembling an additional touch-sensing array. Further, the touch-sensing liquid crystal display 100 of the present embodiment further includes the isolating layer to provide a further blocking effect for blocking the capacitor interference in the liquid crystal layer. It is worthy to be noted that, although the touch-sensing liquid crystal display 100 of the present embodiment includes the isolating layer OC, yet in other embodiments of the present disclosure, the isolating layer OC may be omitted or replaced by another insulating layer.

Although the present disclosure has been described above as in some embodiments, it is not used to limit the present disclosure. It will be intended to those skilled in the art that various modifications and variations can be made to the structure of the present disclosure without departing from the scope or spirit of the disclosure. Therefore, the scope of the disclosure is to be defined solely by the appended claims.

What is claimed is:

1. A touch-sensing liquid crystal display (LCD), comprising:
a display panel, comprising:
a transistor substrate, comprising:
a plurality of data lines for transmitting a plurality of first signals comprising a plurality of image data signals or a plurality of touch-sensing detecting signals;
a plurality of scan lines for transmitting a plurality of second signals comprising a plurality of switch signals or a plurality of touch-sensing scan signals;
a plurality of pixel units, comprising:
a plurality of pixel electrodes; and
a plurality of transistor switches electrically connected to the data lines and the scan lines, wherein the first signals are applied to the pixel electrodes based on the second signals; and
a shield layer which is disposed between the pixel electrodes and the transistor switches, wherein a reference voltage is applied to the shield layer;
a liquid crystal layer disposed on the transistor substrate; and
a common electrode which is disposed on the liquid crystal layer, wherein a common voltage is applied to the common electrode; and
a backlight module disposed on the display panel, wherein the liquid crystal layer is sandwiched between the shield layer and the backlight module.

2. The touch-sensing liquid crystal display of claim 1, wherein the data lines and the scan lines are arranged orthogonally to form a touch-sensing array.

3. The touch-sensing liquid crystal display of claim 1, further comprising:
an isolating layer disposed between the transistor switches and the shield layer

4. The touch-sensing liquid crystal display of claim 3, wherein the isolating layer has a transmittance substantially between 60% and 99%, and the isolating layer has a thickness substantially between 0.2 μm and 3 μm.

5. The touch-sensing liquid crystal display of claim 3, wherein the isolating layer has a transmittance substantially between 10% and 60%, and the isolating layer has a thickness substantially between 1 μm and 5 μm.

6. The touch-sensing liquid crystal display of claim 3, wherein the isolating layer is formed from a Si-containing material or an organic material.

7. The touch-sensing liquid crystal display of claim 1, further comprising:
a sensor for detecting a plurality of capacitances corresponding to a plurality of intersections between the data lines and the scan lines.

8. The touch-sensing liquid crystal display of claim 1, wherein the shield layer is formed from Indium Tin Oxide (ITO).

9. The touch-sensing liquid crystal display of claim 1, wherein the reference voltage has the same value as the common voltage.

10. The touch-sensing liquid crystal display of claim 1, wherein the shield layer is a one-piece structure and has a plurality of openings.

11. The touch-sensing liquid crystal display of claim 10, further comprising an isolating layer which is disposed between the transistor switches and has a plurality of isolating layer openings, wherein the shield layer is disposed corresponding to the scan lines and the data lines, and the openings are disposed corresponding to the isolating layer openings.
